(19) United States
(12) Patent Application Publication
(10) Pub. No.: US 2012/0090235 A1
(43) Pub. Date: Apr. 19, 2012

(54) Apparatus for a Plant Growth Medium

(76) Inventors: Briar Horn, San Rafael, CA (US); Jamin Horn, San Rafael, CA (US)

(21) Appl. No.: 13/271,109

(22) Filed: Oct. 11, 2011

Related U.S. Application Data
(60) Provisional application No. 61/393,156, filed on Oct. 14, 2010.

(51) Int. Cl. A01G 31/02; A01G 9/02

(52) U.S. Cl. 47/59 R; 47/65.9

(57) ABSTRACT

An apparatus comprises a backing sheet comprising a pH neutral material. The backing sheet is configured for supporting at least one plant in a hydroponics system. A plurality of protrusions comprises a pH neutral material. The plurality of protrusions is joined to the backing sheet. The plurality of protrusions is configured for extending away from a surface of the backing sheet for supporting the roots of the at least one plant in which the at least one plant is supported in a growing position and damage to the at least one plant is mitigated during removal of the roots from the protrusions.

### CROSS-REFERENCE TO RELATED APPLICATIONS

The present Utility patent application claims priority benefit of the U.S. provisional application for patent Ser. No. 61/393,156 entitled “A Plastic Growth Media For Use With Plant Growing Systems”, filed on 14 Oct. 2010, under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### CROSS-REFERENCE TO RELATED APPLICATIONS

This utility application is based upon U.S. patent application Ser. No. 61/393,156 filed on 14 Oct. 2010. This related application is incorporated herein by reference and made part of this application. If any conflict arises between the disclosure of the invention in this utility application and that in the related provisional application, the disclosure in this utility application shall govern. Moreover, the inventor incorporates herein by reference any and all patents, patent applications, and other documents hard copy or electronic, cited or referred to in this application.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to hydroponics. More particularly, the invention relates to a plastic or artificial growth medium for use with plant growing systems.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Hydroponics refers to the growing of crops without soil. The only requirements for a plant are air, sunlight, nutrients, water and a medium which the roots can grow into to support the plant. Thus, a basic hydroponics system provides these elements.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that there are three basic types of hydroponic systems, and the type of system used is typically chosen depending on what type of plant is being grown. For plants which can be grown with their roots completely submerged, the system is called aquaponics. For plants which have shallow roots and do not grow particularly high, such as, but not limited to, lettuces, the system is called a flow through system. This system utilizes Nutrient Film Technique (NFT) in which a thin sheet of nutrient solution flows down a channel thereby providing water and nutrients to the plants roots. For larger plants which grow upright, such as, but not limited to, tomatoes, there are two methods of applying nutrient solution in the system. In the first, referred to as top drip, a solution is sprayed or dripped from above onto the medium. In the second method, nutrient solution is pumped into the system until the nutrient solution completely submerges the roots and is then pumped out to allow the roots access to air. The latter type is referred to as an ebb and flow system.

The flow through system does not usually use a medium for root growth. The roots grow half in the air and half in the thin sheet of nutrient solution which flows over the flat canal or table. This typically prevents larger plants from being grown in a flow through system. Aquaponics systems sometimes use a medium and sometimes do not. When a medium is not used in an aquaponics system, the roots of the plants float freely in water. When aquaponics systems do use a medium upon which the roots attach, this medium is typically the same type of medium that is used in an ebb and flow system.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a hydroponics medium essentially assumes the same functions as soil, except that a hydroponics medium does not provide the plant with nutrients. First a hydroponics medium provides a structure upon which the plant's roots can grow in and around, thus providing support and anchoring for a plant, especially where the plant is large and bears fruit or flowers, which adds weight. Second, a hydroponics medium holds a young plant in position, much like soil. When a seedling is planted in a pot of soil, the seedling is placed at the top of the pot and the seedling's roots are allowed to grow outwards and downwards. The same is true in hydroponics, the medium holds the plant at the top of the receptacle allowing the roots to develop and take advantage of the entire area in which it is grown. Thirdly, the medium enables the roots to maximize their surface area by growing around the medium. Finally the medium allows for the controlled mix of nutrient solution and air to reach the roots thus controlling the moisture in the root area.

Current hydroponics mediums can be split into two rough categories. One category includes mediums that are made up of fibers or fibrous products. Coco fiber is one such medium and is made from coconut husks that have been shredded into fibers to form a spongy mat in which the plant is grown. Rockwool cubes made by Grodan are another similar growth medium. Rockwool is a fiberglass substance with the texture of cotton candy in which roots can grow. Other such media are sphagnum moss, sawdust, and similar materials. These all are similar in that they are usually not reusable, at least by the farmer who is implementing them. Rockwool, for example, is used for a single growing cycle, at which point it is usually replaced as the roots become embedded in the medium and begin to decay once the plant has died or been harvested. The rotting roots can seriously affect a hydroponics system. Thus, a farmer using any fibrous medium usually purchases new medium every growth cycle. Another result of utilizing fibrous organic material as a growth medium is that organic matter affects the delicate pH balance which should be achieved for maximum hydroponic plant growth. Coco fiber and other fibrous mediums have an effect on this delicate pH balance and therefore usually require more skill and attention than other pH neutral hydroponics mediums.

The other main type of growth medium is a pellet type. These are such things as gravel, sand, plastic pellets, perlite, glass, rock, Hydroton®, which is expanded clay pellets, or any other type of material which comes in many small pieces within which the roots can grow. These types of mediums are popular. Many of the mineral type pellet mediums, as well as fibrous mediums, shed fine particulate matter which creates a layer of sediment within the hydroponic system. This sediment may result in the clogging of tubes used to pump the nutrient solution in and out of the receptacle in which the plant is grown. This can be a serious problem that may be difficult to diagnose and fix and may cause loss of plants as well as equipment damage and malfunction. The sediment buildup may also result in increased labor costs, as scrubbing the system free of the sediment buildup is time consuming. If a farmer chooses not to reuse one of these types of mediums, the medium must be disposed of and a replacement medium must be bought anew. This adds cost. However, if a farmer chooses to wash the roots out of the medium and reuse it, the farmer becomes involved in a labor-intensive process of attempting to remove stubborn dead and rotting roots from the medium in which they have imbedded themselves. This process usually requires the use a significant quantity of water thus reducing one of the main benefits of hydroponics, namely the associated reduction of water use. This process of removing roots and sanitizing may also substantially add to cost due to the increased labor this process requires. Consequently the farmer currently growing hydroponically is faced with the choice or purchasing, rinsing, and introducing new medium to the system every grow cycle or sanitizing previously used medium for future use. Both options pose serious financial burdens and result in lost grow room time, which could be utilized for the growing of the next generation of plant. This reset time has an associated cost of lost productivity and is generally considered an opportunity cost.

Many of these media, such as gravel, sand, rock and Hydroton®, are also quite heavy and shipping or moving them can be difficult and expensive. Costs associated with shipping and disposal may be substantial.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagrammatic side view of an exemplary growth medium, in accordance with an embodiment of the present invention;

FIG. 2 is a diagrammatic top view of an exemplary growth medium configured for use in a circular bucket, in accordance with an embodiment of the present invention;

FIG. 3 is a diagrammatic top view of exemplary growth mediums configured for use in a square bucket, in accordance with an embodiment of the present invention;

FIG. 4 is a diagrammatic top view of exemplary sheets of growth medium in a grid configuration, in accordance with an embodiment of the present invention;

FIG. 5 is a diagrammatic side view of an exemplary growth medium, in accordance with an embodiment of the present invention; and

FIG. 6 is a diagrammatic side view of exemplary protrusions of various different shapes, in accordance with embodiments of the present invention.

Unless otherwise indicated illustrations in the figures are not necessarily drawn to scale.

### REFERENCE NUMBERS IN THE DRAWINGS

100 growth medium
101 backing sheet
103 protrusions sometimes used to support root growth
200 growth medium configured for a circular bucket
201 backing sheet configured for a circular bucket
203 protrusions of a backing sheet configured for a circular bucket
300 growth medium sheets configured for a square bucket
301 backing for growth medium sheets configured for a square bucket
303 protrusions for growth medium sheets configured for a square bucket
400 growth medium sheets in a grid configuration
401 backing for growth medium sheets in a grid configuration
403 protrusions of a growth medium sheet in a grid configuration, such protrusions are sometimes called “rods.”
500 growth medium sheet with protrusions 503 of various lengths
501 backing for growth medium sheet with protrusions of various lengths
503 protrusions of various lengths
601 grooved protrusion
603 narrow rod protrusion
605 thick rod protrusion
607 wide spike protrusion
609 narrow spike protrusion

### DETAILED DESCRIPTION OF THE PREFERRED EMBODIMENTS

Embodiments of the present invention may be better understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A preferred embodiment of the present invention and at least some variations thereof provide a growth medium comprising a backing to which is connected a series of protrusions which can be varied in length width, taper, shape, and type. Some embodiments are made up of the backing and protrusions arranged in such a way that from an unrolled flat position, may be rolled end to end to form a complete circle. The protrusions may, or may not interlock with each other. Where they do not interlock they may, or may not interact with each other by allowing a user to vary the width of the gaps between protrusions by manipulating the backing in or out of the receptacle in which it is used. When placed in the closed circular position the gaps between the protrusions diminish, when opened the gaps between protrusions open. The interaction of the protrusions is used here to describe the varying of the gaps to as to adjust for either root growth, removal of the root ball, or planting of the plant. Such a closing allows for a properly calibrated spacing for root growth as well as ease of removal of said roots upon unfurling of the circular form. Some embodiments may not unfurl at all but rather stay in a position where the protrusions remain static in relation to one another. Other embodiments may interact with themselves by folding the backing onto itself, and the protrusions may or may not interlock with each other. Such an embodiment may be formed by passing the protrusions of two backings together through the opposite backing, or may interlock or interact with any other type of medium which may be placed between the protrusions. Interlock is used herein to describe the crossing of a protrusion or protrusions from one side of a backing crossing the plane made up of the tips of the protrusions furthest from the backing to which they are connected. Interlocking may also describe the crossing of a protrusion or protrusions into any other area formed by protrusions of the same or a different backing. The area where the protrusions interlock is herein described as the interlocking area.

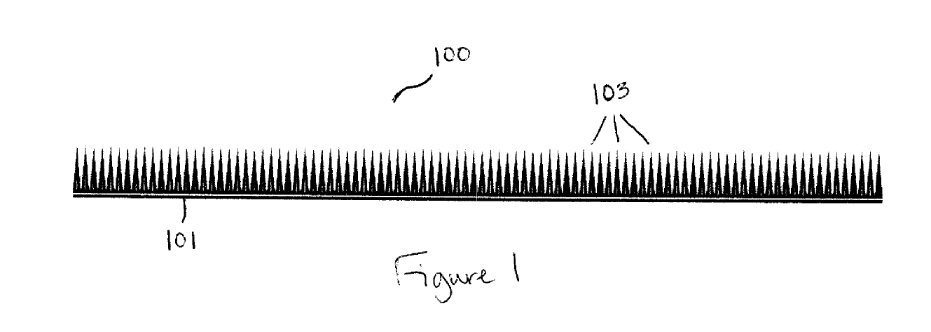

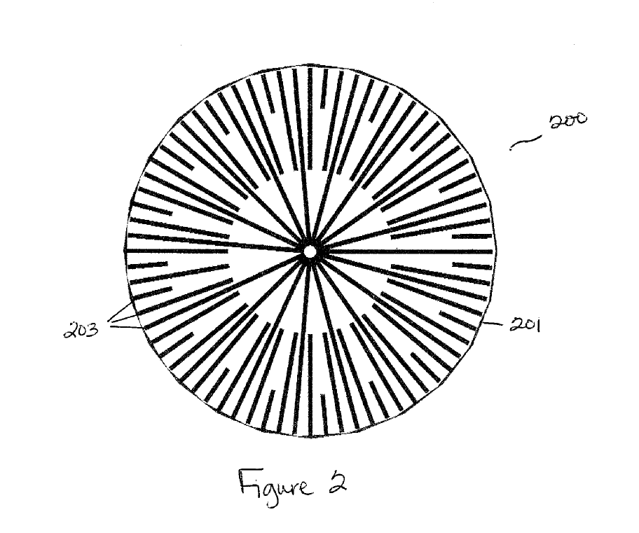

FIG. 1 is a diagrammatic side view of an exemplary growth medium 100, in accordance with an embodiment of the present invention. In the present embodiment, growth medium 100 comprises a backing sheet 101 with a sufficient number of protrusions 103 to support the root growth of a plant. That is a plant can grow into growth medium 100 and protrusions 103 are able to provide structure for the roots. On growth medium 100, protrusions 103 are all the same size and evenly spaced on backing 101; however, in alternate embodiments, the number of protrusions and their configuration may vary a great deal. For example, without limitation, in some alternate embodiments, the protrusions can be designed and specifically tailored for specific applications or for specific plants. Furthermore, the shape of the protrusions may vary in alternate embodiments. In the present embodiment, backing 101 is preferably made of a lightweight, flexible and reusable material such as, but not limited to, a type of plastic; however, other types of flexible and reusable materials may be used such as, but not limited to, composites or rubber. Some embodiments may utilize the same material for both the backing as well as the protrusions. In other embodiments the material utilized for the backing may be selected primarily for it resilience and flexibility, whereas the material for the protrusions may be of another substance which could provide additional benefits including, but not limited to, the absorption of water, resilience, strength, and flexibility. Some alternate embodiments may comprise non-flexible backings that are made of more rigid materials such as, but not limited to, metal, harder plastics, ceramic, etc. In the present embodiment, the flexibility of backing 101 enables protrusions 130 to interact with each other by curving backing 101 onto itself into a circular structure, as shown by way of example in FIG. 2. By using the preferred material of plastic, growth medium 100 is lightweight, can be easily cleaned and produces virtually no sediment build up. Growth medium 100 is also pH neutral and has minimal effect on the temperature of a hydroponic solution.

In typical use of the present embodiment, a plant is placed within or next to growth medium 100 so that protrusions 103 provide physical support for the growth of the plant's root system. The plant is typically a small plant at this point, and as it grows, the roots of the plant grow around and fill the spaces between protrusions 103. Growth medium 100 provides the ability to control the level of water retained in the root zone and to optimize the media for each plants' specific rooting conditions by controlling the spacing and water retention in which the root growth occurs. Using the present embodiment, a user can remove the entire growth medium 100 and plant from a hydroponic system to easily access areas of the system.

The present embodiment addresses a number of problems associated with traditional growth mediums. First, growth medium 100 is reusable. Growth medium 100 may also be used in a variety of positions. For example, without limitation, growth medium 100 can be placed flat with the plant above it or can fold over onto itself for use in a circular bucket. In another exemplary application, two sheets are pressed together so as to interlock. One sheet may be placed upside down with the tips of the protrusions touching the bottom of a nutrient film technique, or any other nutrient solution flow, channel or table. In virtually any application using the present embodiment, only one or two parts are used in the entire medium enabling the growing system to be simple to create and use. Furthermore, growth medium 100 enables a user to view a plant's roots by opening or peeling back backing 101 of growth medium 100, which is something that cannot be done with any traditional medium type. This can help to assess plant growth and root development and to diagnose and treat any nutritional deficiencies or plant diseases at the root. This also enables a user to easily plant or remove and change plants that have already rooted into growth medium 100. This provides for particularly easy planting in situations where plants are started outside the system in any other medium, for example, without limitation, in rockwool cubes, aeroponics, or rooting tables. When removing a plant from growth medium 100, a user can remove the root ball entirely with minimal breaking of the plant roots or any media around the roots. Furthermore, as this medium is made up of one or two interacting and possibly interlocking parts it is quite easy to remove a plant by un-interlocking or unfolding the backing to provide greater space between the protrusions thus allowing the user to easily remove the root ball by simply pouring or pulling the plant roots out of the medium leaving little or no plant material in the medium. The medium can then be sprayed or soaked to cleanse and sanitize for reuse. As the preferred material for the growth medium is a type of plastic, there are generally no issues with sediment clogging tubes used to transport water and nutrients throughout the hydroponic system.

Those skilled in the art, in light of the present teachings, will readily recognize that a growth medium according to the present embodiment may be used in various different applications. For example, without limitation, growth medium 100 may be used in basically any hydroponics system which uses individualized buckets or receptacles to hold plants in position or to hold a nutrient solution including, but not limited to, aeroponics, aquaponics, ebb and flow hydroponics, drip system hydroponics, etc. Aeroponics is a method of hydroponic growth where the roots are suspended below the plant body in a chamber which is heavily humidified by misting emitters. If heavily perforated with protrusions sufficient to provide a structure for the plant, growth medium 100 can be inserted into a perforated plastic cup for use in an aeroponics system or as a standalone receptacle. Likewise for plants that are grown aquaponically, that is where the root system is fully suspended in a solution, a similar arrangement can be used with growth medium 100 to allow the roots to grow into the water but which also provides structure and ease of cleaning Growth medium 100 may also be used as a support structure in non-bucket hydroponics systems, such as, but not limited to, NFT (nutrient film technique) systems where there is an interlocking of two sheets of growth medium 100. Growth medium 100 may also be used as a support in any growing system where roots use protrusions 103 as support for example, without limitation, in buckets with soil or other media in order to reduce weight or use of other media. Furthermore, growth medium 100 may be used in channel or NFT systems, either on the bottom or on the sides of the system, to provide support to the roots where the backing 101 does not bend or interlock with protrusions 103.

The present embodiment is originally designed as an alternative to current hydroponics mediums; however, it is able to be used for other applications such as, but not limited to, in green roofs and walls as a growth media, as backing for use with other media such as, but not limited to, fibrous, gravel or soil bases hydroponics media, or as a stand-alone product. In green walls and roofs, there is a need for a lightweight media or media backing which provides support for plant growth and reduces the amount of soil needed as soil soaks up water and can become too heavy to be supported by a building. For green walls growth medium 100 can provide a structure upon which the roots of plants can grow. Two strips or panels of growth medium 100 are preferably used, one whose backing 101 faces a wall and the other interlocked and pressed against the first. The top, or outer backing 101, can be perforated to allow for the addition of plants. Another growth media or soil can be inserted between the two panels of growth medium 100. For a green roof a single panel of growth medium 100 can be used which is perforated to enable water to flow through and drain. In this application, protrusions 103 are preferably varied to provide an easy to grip surface for plant roots, for example, without limitation, circular or notched type protrusions. Currently, in order to plant shrubs or small trees on a roof, the roof must have a certain depth of soil. The depth provides stability for the larger plants so they will not be blown or fall over. The addition of growth medium 100 attached to the roof and then covered in soil provides greater grip for a plant's roots on the roof through the roots attaching to protrusions 103. This enables larger plants to be used on green roofs without requiring as great a depth of soil or media. This in turn reduces the need for building of a stronger structure or for significant engineering modifications to existing structures or plans.

There are three major types of hydroponics systems in which the present embodiment can be used. First, there are the ebb and flow type systems where a bucket is filled with hydroponic solution and then drained on a timer. The buckets are usually circular or square in shape. FIG. 2 is a diagrammatic top view of an exemplary growth medium 200 configured for use in a circular bucket, in accordance with an embodiment of the present invention. In the present embodiment, a single piece of growth medium 200 can be folded in such a way that it inserts perfectly into the bucket with a backing 201 coming full circle and interacting with itself with the help of protrusions 203. The plant can be placed in the center, either as a small plant in a rockwool cube or by itself, depending on the situation. The plant then grows, the roots filling in the spaces between protrusions 203. At the end of a grow cycle to clean the root from growth medium 200, growth medium 200 can be pulled out of the bucket along with the intertwined root system. Then, growth medium 200 is unfolded flattened and disengaged from itself, and the root ball of the plant is then dumped from growth medium 200. Growth medium 200 can then be washed and reused. In the present embodiment, protrusions 203 vary in length to enable backing 201 to more easily fold into a circular shape; however, in alternate embodiments, the protrusions may all be the same length. Furthermore, in some alternate embodiments, the protrusions may not be long enough to reach the center of the circle created by the backing of the growth medium. Those skilled in the art, in light of the present teachings, will readily recognize that this configuration of growth medium may be used in various different applications such as, but not limited to, in other types of cylindrical receptacles, in receptacles of various different shapes, etc.

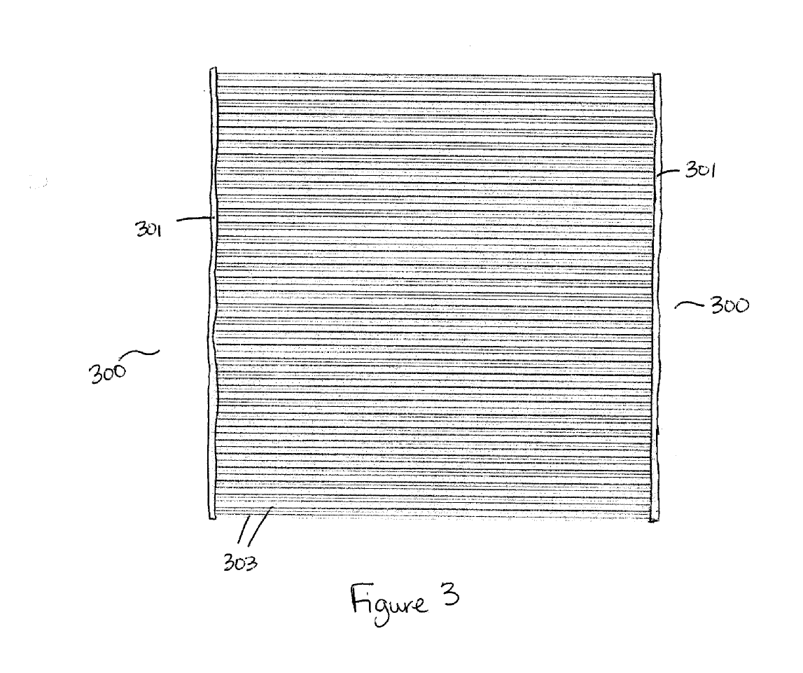

FIG. 3 is a diagrammatic top view of exemplary growth medium sheets 300 configured for use in a square bucket, in accordance with an embodiment of the present invention. In the present embodiment, two growth medium sheets 300 face each other with backings 301 on the outside. Protrusions 303, on each backing 301, interlock with the opposite backing 301 to hold growth medium sheets 300 in place. In alternate embodiments, the growth medium sheets may not interlock. In the present embodiment, a plant can be inserted in the middle of a growth medium sheet 300, either in a grow cube or alone, and the second growth medium sheet 300 is pushed onto the first so they interlock. Then, growth medium sheets 300 and the plant are inserted into the bucket. Similarly to the foregoing example, at the end of the grow cycle the plant and the two growth medium sheets 300 can be taken from the bucket, growth medium sheets 300 pulled apart and the root ball removed. In the present embodiment, protrusions 303 are all the same length; however, in alternate embodiments, the lengths of the protrusions may vary. Furthermore, this growth medium configuration may be used in various different applications such as, but not limited to, in troughs, in receptacles of various different shapes, etc.

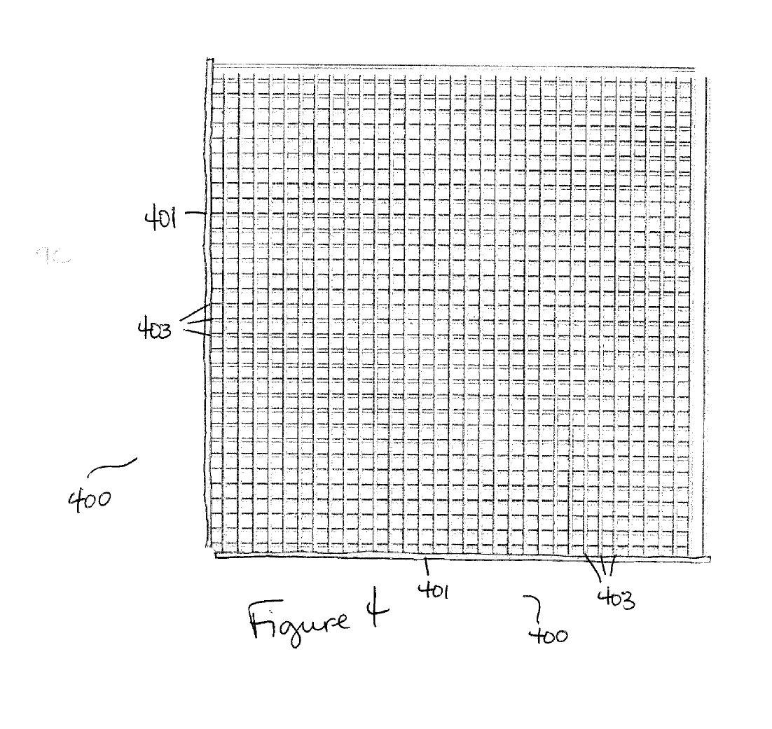

FIG. 4 is a diagrammatic top view of exemplary growth medium sheets 400 in a grid configuration, in accordance with an embodiment of the present invention. In the present embodiment, two or more growth medium sheets 400 are interlocked so that backings 401 and protrusions 403 are perpendicular to each other and create a grid to support the roots of the plant. When perpendicular sheets create an interlocked matrix in which a plant can grow, the rods pass by one another in perpendicular fashion creating a structurally sound configuration where many perpendicular interactions of individual rods synergistically create a very resilient interaction. This configuration may be useful in situations in which the roots need substantial support for example, without limitation, for larger plants or fruit bearing plants. This configuration may also be used for applications described by way of example in accordance with FIG. 3 such as, but not limited to, in a square receptacle or in a trough.

Another type of hydroponics system where an embodiment of the present invention can be used is with certain types of flow through systems. A flow through system is a system in which a trough is used upon which flows a sheet of hydroponic nutrient solution. The plants are put directly into the flow in rockwool cubes, in a net bucket, or merely in the trough alone. For these systems a layer of growth medium with protrusions can be put in the trough or channel, fit to the proper width, or directly on the table and the nutrient solution can run in a sheet along the protrusion side of the backing. This may allow large plants, which require root stability, to be grown in flow through systems. In some applications a second sheet of growth medium can be placed along the trough above the first sheet with the protrusions interlocking. The top sheet's backing preferably comprises perforations fit to the size of the plant or protrusions rockwool cube which is to be inserted. The growth medium provides support to the plant roots while allowing the solution to flow from the emitter to the drain. Upon the termination of the plant cycle the growth medium may be removed from the system, disengaged, and washed.

Those skilled in the art, in light of the present teachings, will readily recognize that alternate embodiments of the present invention may comprise backings or protrusions that vary from the embodiments described in the foregoing. For example, without limitation, the backing may be perforated in places in order to allow for root growth through the backing or to allow liquids to flow through the perforated areas. In some embodiments comprising perforated backings, protrusions may be omitted since the perforations provide spaces in which the roots of a plant may grow.

A multiplicity of suitable variations on the protrusions may be employed in alternate embodiments of the present invention. For example, without limitation, the length of the protrusions can be varied so as to create an embodiment where each protrusion can be lengthened so they will touch the opposite backing, which may be opposite a circle where the backing is folded around itself or the backing which is opposite where two backings are facing each other protrusion side to protrusion side, or come as close to the backing as physical limitations allow. In another alternate embodiment, each protrusion can be shortened to the point where the protrusions are minimal and do not interlock with each other yet may interact or interlock with any media that is placed between the protrusions or, where no media is used, may provide a physical support on which roots may grow. Furthermore, the width and taper of each protrusion can be varied in some alternate embodiments to provide, across the whole of each implementation, different spacing between protrusions at different points throughout the interaction with itself or with an associated similar component.

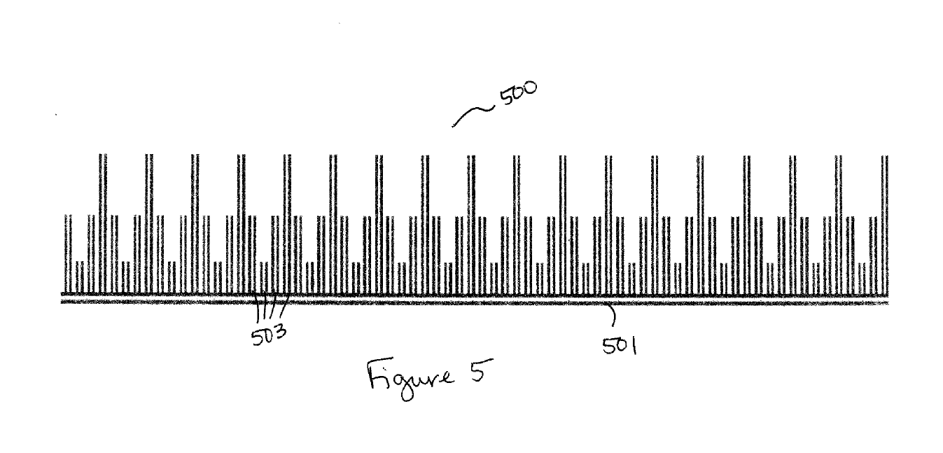

FIG. 5 is a diagrammatic side view of an exemplary growth medium 500, in accordance with an embodiment of the present invention. In the present embodiment, a backing 501 comprises protrusions 503 made up of a mixture of lengths. Alternate embodiments may also comprise protrusions with a mixture of tapers, widths, and/or shapes so as to create the desired interaction profile. That is the desired spacing between non-interlocking protrusions, the desired spacing where protrusions interlock, or the desired spacing where the protrusions interact with another media or with the plant root itself.

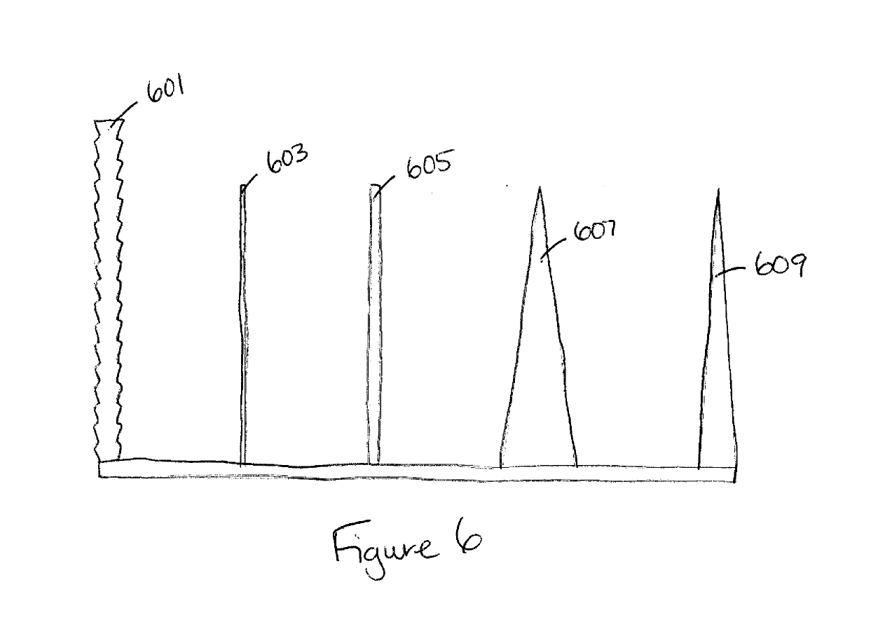

FIG. 6 is a diagrammatic side view of exemplary protrusions of various different shapes, in accordance with embodiments of the present invention. The general shape of each protrusion may be varied so as to provide more support for a root. Each protuberance may be shaped in a different manner for example be notched, beaded, or have grooves oriented in a manner designed to catch water in ebb and flow or drip type systems and therefore may increase the plants access to residual water which may increase humidity to the root zone. In the present example a grooved protrusion 601, a narrow rod protrusion 603, a thick rod protrusion 605, a wide spike protrusion 607, and a narrow spike protrusion 609 are shown. Alternate embodiments may comprise protrusions of various different shapes such as, but not limited to, curved protrusions, corkscrew protrusions, angled protrusions, hollow protrusions, tapered protrusions, and protrusions which split from one to more than one protrusion moving from its base to its end.

Having fully described at least one embodiment of the present invention, other equivalent or alternative methods of providing a lightweight and reusable growth medium according to the present invention will be apparent to those skilled in the art. The invention has been described above by way of illustration, and the specific embodiments disclosed are not intended to limit the invention to the particular forms disclosed. For example, the particular implementation of the protrusions may vary depending upon the particular type of growth medium used. The growth mediums described in the foregoing were directed to implementations that are completely covered in protrusions; however, similar techniques are to provide growth mediums that only have protrusions in strategic locations. Implementations of the present invention that are not completely covered in protrusions are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

Embodiments of the invention include, but are not limited to the following items.
1. Item 1. An apparatus comprising:
   a backing sheet comprising a pH neutral material, said backing sheet being configured for supporting at least one plant in a hydroponics system; and
   a plurality of protrusions comprising a pH neutral material, said plurality of protrusions being joined to said backing sheet, said plurality of protrusions being configured for extending away from a surface of said backing sheet for supporting the roots of the at least one plant in which the at least one plant is supported in a growing position and damage to the at least one plant is mitigated during removal of the roots from said protrusions.
2. The apparatus as recited in item 1, in which said backing sheet is further configured to be removable from the hydroponics system.
3. The apparatus as recited in item 1, in which said backing sheet further comprises a flexible material.
4. The apparatus as recited in item 3, in which said backing sheet is further configured for folding into a circular shape with said protrusions extending inward.
5. The apparatus as recited in item 1, in which lengths of said protrusions vary.
6. The apparatus as recited in item 1, in which said protrusions are further configured for supporting a growth medium with the at least one plant.
7. The apparatus as recited in item 1, in which said backing sheet is further configured to be positioned facing a like backing sheet in which said protrusions interlock with protrusions of the like backing sheet.
8. The apparatus as recited in item 1, in which said backing sheet is further configured to be positioned at an angle adjacent to a like backing sheet in which said protrusions interlock with protrusions of the like backing sheet.
9. The apparatus as recited in item 1, in which said protrusions further comprise shapes for retaining water.
10. The apparatus as recited in item 1, in which said backing sheet further comprises perforations.
11. The apparatus as recited in item 1, in which said backing sheet and said protrusions further comprise a plastic material.
12. An apparatus comprising:
   means for supporting at least one plant in a hydroponics system and to be removable from the hydroponics system; and
   means for extending away from a surface of said backing sheet for supporting the roots of the at least one plant in which the at least one plant is supported in a growing position and damage to the at least one plant is mitigated during removal of the roots from said extending means.
13. An apparatus comprising:
   a backing sheet comprising a pH neutral flexible plastic material, said backing sheet being configured for supporting at least one plant in a hydroponics system and to be removable from the hydroponics system; and
   a plurality of protrusions comprising a pH neutral flexible plastic material, said plurality of protrusions being joined to said backing sheet, said plurality of protrusions being configured for extending away from a surface of said backing sheet for supporting the roots of the at least one plant in which the at least one plant is supported in a growing position and damage to the at least one plant is mitigated during removal of the roots from said protrusions.
14. The apparatus as recited in item 13, in which said backing sheet is further configured for folding into a circular shape with said protrusions extending inward.
15. The apparatus as recited in item 13, in which lengths of said protrusions vary.
16. The apparatus as recited in item 13, in which said protrusions are further configured for supporting a growth medium with the at least one plant.
17. The apparatus as recited in item 13, in which said backing sheet is further configured to be positioned facing a like backing sheet in which said protrusions interlock with protrusions of the like backing sheet.
18. The apparatus as recited in item 13, in which said backing sheet is further configured to be positioned at an angle adjacent to a like backing sheet in which said protrusions interlock with protrusions of the like backing sheet.
19. The apparatus as recited in item 13, in which said protrusions further comprise shapes for retaining water.
20. The apparatus as recited in item 13, in which said backing sheet further comprises perforations.

What is claimed is:

1. A growth medium apparatus comprising:
a backing sheet comprising a pH neutral material, said backing sheet being configured for supporting at least one plant; and
a plurality of protrusions comprising a pH neutral material, said plurality of protrusions being joined to said backing sheet, said plurality of protrusions extending away from a surface of said backing sheet for supporting the roots of the at least one plant in which the at least one plant is supported in a growing position and

2. The apparatus as recited in claim 1, in which said backing sheet is further configured to be removable from the hydroponics system.

3. The apparatus as recited in claim 1, in which said backing sheet further comprises a flexible material.

4. The apparatus as recited in claim 3, in which said backing sheet is further configured for bending into a circular shape with said protrusions extending inward.

5. The apparatus as recited in claim 1, in which lengths of said protrusions vary.

6. The apparatus as recited in claim 1, in which said protrusions are further configured for supporting a growth medium with the at least one plant.

7. The apparatus as recited in claim 1, in which said backing sheet is further configured to be positioned facing a like backing sheet in which said protrusions interlock with protrusions of the like backing sheet.

8. The apparatus as recited in claim 1, in which said backing sheet is further configured to be positioned at an angle adjacent to a like backing sheet in which said protrusions interlock with protrusions of the like backing sheet.

9. The apparatus as recited in claim 1, in which said protrusions are intended to form concave water retention surfaces. reta

10. The apparatus as recited in claim 1, in which said backing sheet further comprises perforations.

11. The apparatus as recited in claim 1, in which said backing sheet and said protrusions further comprise a plastic material.

12. An apparatus comprising:
means for supporting at least one plant in a hydroponics system and the apparatus being removable from the hydroponics system; and
means for extending away from a surface of said backing sheet for supporting the roots of the at least one plant in which the at least one plant is supported in a growing position and damage to the at least one plant is mitigated during removal of the roots from said extending means.

13. An apparatus comprising:
a backing sheet comprising a pH neutral flexible plastic material, said backing sheet being configured for supporting at least one plant in a hydroponics system and to be removable from the hydroponics system; and
a plurality of protrusions comprising a pH neutral flexible plastic material, said plurality of protrusions being joined to said backing sheet, said plurality of protrusions being configured for extending away from a surface of said backing sheet for supporting the roots of the at least one plant in which the at least one plant is supported in a growing position and damage to the at least one plant is mitigated during removal of the roots from said protrusions. Describe how mitigated.

14. The apparatus as recited in claim 13, in which said backing sheet is further configured for folding into a circular shape with said protrusions extending inward.

15. The apparatus as recited in claim 13, in which lengths of said protrusions vary.

16. The apparatus as recited in claim 13, in which said protrusions are further configured for supporting a growth medium with the at least one plant.

17. The apparatus as recited in claim 13, in which said backing sheet is further configured to be positioned facing a like backing sheet in which said protrusions interlock with protrusions of the like backing sheet.

18. The apparatus as recited in claim 13, in which said backing sheet is further configured to be positioned at an angle adjacent to a like backing sheet in which said protrusions interlock with protrusions of the like backing sheet.

19. The apparatus as recited in claim 13, in which said protrusions further comprise shapes for retaining water.

20. The apparatus as recited in claim 13, in which said backing sheet further comprises perforations.
